(19) United States
(12) Patent Application Publication
(10) Pub. No.: US 2018/0042278 A1
(43) Pub. Date: Feb. 15, 2018

(54) Protein Enriched Hummus Compositions and Methods of Making Same

(71) Applicant: Prommus Brands LLC, Chicago, IL (US)

(72) Inventors: Anthony Brahimsha, Chicago, IL (US); Shakeel Ur-Rehman, Naperville, IL (US); Michael J. McCloskey, DeMotte, IN (US); Timothy Peter Doelman, Glencoe, IL (US)

(21) Appl. No.: 15/671,466

(22) Filed: Aug. 8, 2017

Related U.S. Application Data
(60) Provisional application No. 62/372,829, filed on Aug. 10, 2016.

(51) Int. Cl. A23L 11/00; A23L 3/36; A23L 33/19

(52) U.S. Cl. CPC A23L 11/05; A23L 33/19; A23L 3/36

(57) ABSTRACT

Protein enriched hummus compositions, mixtures, and products are disclosed within, along with the production thereof. Processes and methods for producing hummus products having increased nutritional value and improved consistency also are disclosed.

### REFERENCE TO RELATED APPLICATION

This application claims the benefit of U.S. Provisional Patent Application No. 62/372,829, filed on Aug. 10, 2016, the disclosure of which is incorporated herein by reference in its entirety.

### BACKGROUND OF THE INVENTION

The present invention relates generally to protein enriched hummus compositions, and processes and methods of making such protein enriched hummus compositions. The processes and methods disclosed herein can be used to improve the nutritional value, taste, and consistency of hummus products, through the addition of non-leguminous protein.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Protein enriched hummus compositions, mixtures, and products are disclosed herein. In accordance with an embodiment of this invention, a protein enriched hummus composition is provided, and in this embodiment, the protein enriched hummus composition can comprise (i) chickpeas and (ii) from about 2 wt. % to about 30 wt. % of a non-leguminous protein, based on the weight of the protein enriched hummus composition.

Processes for producing protein enriched hummus products also are disclosed herein, as well as methods for improving the consistency of hummus products. In certain embodiments of the present invention, such processes and methods can comprise combining a cooked chickpea component with a non-leguminous protein to form a protein enriched hummus mixture. In certain embodiments, the weight ratio of the cooked chickpea component to the non-leguminous protein can be in a range from about 3:1 to about 15:1. Further, the amount of the non-leguminous protein in the hummus product can be in a range from about 2 wt. % to about 30 wt. %, and the weight ratio of non-leguminous:leguminous protein in the hummus product often can range from about 2:1 to about 10:1.

Beneficially, these processes and methods can result in hummus compositions, mixtures, and products with increased nutritional value. Unexpectedly, the addition of non-leguminous protein can result in hummus compositions, mixtures, and products having improved consistency, texture, and creaminess.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects and embodiments may be directed to various feature combinations and sub-combinations described in the detailed description.

### BRIEF DESCRIPTION OF THE FIGURE

FIG. 1 presents photos illustrating the consistency of a hummus product without protein enrichment (Comparative Example 1), a hummus product comprising 5 wt. % added whey protein isolate (Inventive Example 2), and a hummus product comprising 10 wt. % added whey protein isolate (Inventive Example 3).

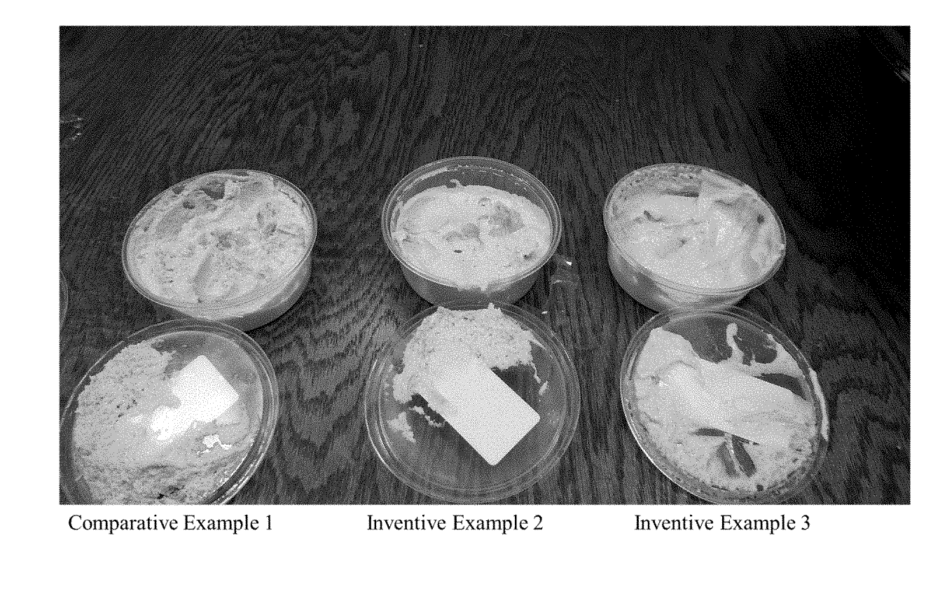

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter can be described such that, within particular aspects and/or embodiments, a combination of different features can be envisioned. For each and every aspect, and/or embodiment, and/or feature disclosed herein, all combinations that do not detrimentally affect the designs, compositions, processes, and/or methods described herein are contemplated with or without explicit description of the particular combination. Additionally, unless explicitly recited otherwise, any aspect, and/or embodiment, and/or feature disclosed herein can be combined to describe inventive features consistent with the present disclosure.

While compositions and processes are described herein in terms of “comprising” various components or steps, the compositions and methods can also “consist essentially of” or “consist of” the various components or steps, unless stated otherwise.

The terms “a,” “an,” “the,” etc., are intended to include plural alternatives, e.g., at least one, unless otherwise specified. For instance, the disclosure of “a non-leguminous protein” or “an animal protein” is meant to encompass one, or mixtures or combinations of more than one, non-leguminous protein or animal protein, respectively, unless otherwise specified.

In the disclosed processes, the term “combining” encompasses the contacting of components in any order, in any manner, and for any length of time, unless otherwise specified. For example, the components can be combined by blending or mixing.

The term “chickpea” is used herein to describe any form of chickpea, inclusive of both raw chickpeas, and chickpeas processed by any suitable means or any means disclosed herein. For example, “chickpeas” may include whole chickpeas or portions of chickpeas, ground chickpeas, steamed chickpeas, boiled chickpeas, chickpea paste, and the like.

Although any methods, devices, and materials similar or equivalent to those described herein can be used in the practice or testing of the invention, the typical methods, devices, and materials are herein described.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the non-leguminous protein content of the composition can be in certain ranges in various aspects of this invention. By a disclosure that the non-leguminous protein content can be in a range from about 4 to about 20 wt. %, the intent is to recite that the non-leguminous protein content can be any non-leguminous protein content within the range and, for example, can be equal to about 4, about 5, about 6, about 7, about 8, about 9, about 10, about 11, about 12, about 13, about 14, about 15, about 16, about 17, about 18, about 19, or about 20 wt. %. Additionally, the non-leguminous protein content can be within any range from about 4 to about 20 wt. % (for example, from about 5 to about 10 wt. %), and this also includes any combination of ranges between about 4 and about 20 wt. %. Likewise, all other ranges disclosed herein should be interpreted in a manner similar to this example.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities. The term “about” can mean within 10% of the reported numerical value, preferably within 5% of the reported numerical value.

### DETAILED DESCRIPTION OF THE INVENTION

The present invention is directed generally to protein enriched hummus compositions, processes for producing protein enriched hummus compositions, methods for improving the consistency of protein enriched hummus compositions, mixtures, and products produced using these processes and methods. In particular, the present invention relates to hummus mixtures comprising non-leguminous protein, and processes for preparing, combining, mixing, blending, packaging, and/or sterilizing hummus mixtures comprising non-leguminous protein.

### Protein Enriched Hummus Compositions

Protein enriched hummus compositions comprising chickpeas and a non-leguminous protein are disclosed and described herein. Protein enriched hummus compositions can provide advantages over standard hummus products comprising only chickpea protein, such as increased nutritional value and a more desirable texture, flavor, color, and/or consistency. The chickpeas of the protein enriched hummus compositions disclosed herein are not limited to any particular form. Generally, however, chickpeas of the protein enriched hummus compositions disclosed herein are in a form that allows the chickpeas to be easily combined with other ingredients to form a homogenous mixture. For example, chickpeas can often be present as ground chickpeas, mashed chickpeas, blended chickpeas, chickpea paste, chickpea puree, etc. In certain embodiments, the non-leguminous protein of the protein enriched hummus compositions disclosed herein can comprise an animal protein, a plant protein, or both. In certain embodiments, the non-leguminous protein can comprise casein, whey protein in the form of whey protein isolate, whey protein concentrate, and/or alpha-lactalbumin, or any combination thereof.

As would be recognized by those skilled in the art in view of this disclosure, the protein enriched hummus compositions disclosed herein can further comprise any suitable additional ingredients, for instance, flavorants, spices, fruits and/or fruit juices, vegetables, oils, protein sources, preservatives, additives such as acidifying agents and/or processing aids, or combinations thereof. Certain embodiments of protein enriched hummus compositions disclosed herein can contain no artificial preservatives. In certain illustrative and non-limiting embodiments, additional ingredients can include olive oil, lemon juice, salt, garlic, brine, tahini, sesame seeds, or any combination thereof. In some embodiments, additional ingredients can include peppers, olives, avocados, or any combination thereof. In certain embodiments, protein enriched hummus compositions can further comprise additional leguminous protein. Illustrative and non-limiting examples of additional leguminous proteins include bean protein, soybean protein, black bean protein, pea protein, lentil protein, nut protein, peanut protein, pulses, or any combination thereof.

Moreover, chickpeas can be present in the protein enriched hummus composition in any suitable amount, such as at least 20 wt. %, at least 40 wt. %, at least 50 wt. %, at least 55 wt. %, at least 60 wt. %, or at least 65 wt. %. Alternatively, the wt. % of chickpeas in the protein enriched hummus composition can be in a range from about 20 wt. % to about 90 wt. %, from about 40 wt. % to about 80 wt. %, from about 45 wt. % to about 70 wt. %, from about 50 wt. % to about 65 wt. %, or from about 55 wt. % to about 65 wt. %. Other appropriate amounts of chickpeas in the protein enriched hummus compositions are readily apparent from this disclosure.

Non-leguminous protein can be present in the protein enriched hummus composition in any amount that can provide a nutritional product and a suitable consistency, such as at least about 2 wt. %, at least about 3 wt. %, at least about 4 wt. %, at least about 6 wt. %, at least about 8 wt. %, at least about 10 wt. %, at least about 12 wt. %, at least about 15 wt. %, at least about 20 wt. %, or at least about 30 wt. %. For instance, protein enriched hummus compositions disclosed herein can comprise non-leguminous protein in a range of from about 2 wt. % to about 30 wt. %, from about 4 wt. % to about 20 wt. %, from about 5 wt. % to about 10 wt. %, from about 6 wt. % to about 15 wt. %, from about 6 wt. % to about 20 wt. %, from about 8 wt. % to about 20 wt. %, from about 8 wt. % to about 15 wt. %, or from about 8 wt. % to about 12 wt. %. Protein enriched hummus compositions having other appropriate amounts of non-leguminous protein are readily apparent from this disclosure.

Generally, the weight ratio of non-leguminous protein to leguminous protein can be within any suitable range that affords a desirable texture, consistency, and nutritional value to the protein enriched hummus composition. In certain embodiments, the weight ratio of non-leguminous protein to leguminous protein can be at least about 1:10, at least about 1:5, at least about 1:2, at least about 1:1, or at least about 2:1. In certain embodiments, the weight ratio of non-leguminous protein to leguminous protein can be in a range from about 1:10 to about 10:1, from about 1:1 to about 10:1, from about 2:1 to about 10:1, from about 2:1 to about 6:1, from about 1:5 to about 5:1, from about 1:2 to about 4:1, or from about 1:1 to about 3:1.

Further, the protein enriched hummus composition can be described by its nutritional characteristics, in particular, the absolute and relative amounts of proteins, carbohydrates, and fats. Proteins can generally be present in any amount suitable to provide a protein enriched hummus composition with a desirable nutritional value, texture, and consistency. For example, in certain embodiments, the wt. % protein of the protein enriched hummus composition (i.e., leguminous and non-leguminous protein; total protein content) can be at least 8 wt. %, at least 10 wt. %, at least 12 wt. %, at least 15 wt. %, at least 18 wt. %, at least 22 wt. %, at least 25 wt. %, or at least 30 wt. %. In certain embodiments, the wt. % protein of the protein enriched hummus composition can be in a range from about 8 wt. % to about 40 wt. %, from about 10 wt. % to about 25 wt. %, from about 12 wt. % to about 30 wt. %, from about 14 wt. % to about 25 wt. %, from about 16 wt. % to about 25 wt. %, from about 18 wt. % to about 25 wt. %, from about 20 wt. % to about 25 wt. %, from about 12 wt. % to about 20 wt. %, from about 14 wt. % to about 20 wt. %, or from about 15 wt. % to about 17 wt. %.

Similar to proteins, the carbohydrates and fats can generally be present in the protein enriched hummus composition in any suitable amount that provides desirable nutritional value, texture and consistency. In certain illustrative and non-limiting embodiments, a weight ratio of protein to carbohydrates can be in a range from about 1:10 to about 10:1, from about 1:10 to about 5:1, from about 1:10 to about 2:1, from about 1:10 to about 1:1, from about 1:5 to about 1:1, or from about 1:5 to about 1:2. Likewise, a weight ratio of protein to fats can be in a range from about 1:10 to about 10:1, from about 1:10 to about 5:1, from about 1:10 to about 2:1, from about 1:10 to about 1:1, from about 1:5 to about 1:1, or from about 1:5 to about 1:2. Other appropriate absolute and relative amounts of proteins, fats, and carbohydrates are readily apparent from this disclosure.

In certain embodiments comprising brine, the brine can consist essentially of salt and water. Alternatively, the brine can comprise salt, water, and other spices, flavorants, additives, or any combination thereof. For example, the brine can comprise aquafaba, an aqueous solution having been contacted with beans during processing or storage. In some embodiments, aquafaba may comprise chickpea brine obtained during processing of the chickpeas of the protein enriched hummus composition, as discussed hereinbelow. In certain embodiments, although not limited to any particular amount, the wt. % brine can be at least about 2 wt. %, at least about 4 wt. %, or at least about 8 wt. %. Alternatively, the wt. % brine can be in a range from about 2 wt. % to about 12 wt. %, from about 4 wt. % to about 10 wt. %, or from about 6 wt. % to about 9 wt. %, based on the total weight of the protein enriched hummus composition.

The pH of the protein enriched hummus composition is not limited to any particular pH range. Generally, however, the pH range can be in a range suitable to preserve the protein enriched hummus composition, comply with FDA guidelines, and produce an appealing taste and/or consistency. For example, the pH of protein enriched hummus compositions often can be less than about 4.6, less than about 4.5, less than about 4.4, less than about 4.3, less than about 4.2, less than about 4.1, or less than about 4. In certain embodiments, the pH can be in a range from about 3.8 to about 4.6, from about 4 to about 4.6, from about 4.2 to about 4.6, from about 4.3 to about 4.6, from about 4 to about 4.5, or from about 4.2 to about 4.5.

In certain embodiments, the protein enriched hummus composition can comprise an acidifying agent to obtain or maintain any suitable pH disclosed herein. Generally, the acidifying agent can be any acidic food-grade additive. For example, in some embodiments, the acidifying agent can comprise glucono delta-lactone, citric acid, tartaric acid, ascorbic acid, lactic acid, hydrochloric acid, fumaric acid, vinegar, liquid or solid carbon dioxide, sodium acid sulfate, and the like, or any combination thereof. The amount of acidifying agent in the hummus composition can be any amount necessary to achieve a suitable pH. In certain embodiments, the amount of the acidifying agent can be from about 0.1 wt. % to about 3 wt. %, from about 0.1 wt. % to about 1 wt. %, from about 0.5 wt. % to about 3 wt. %, or from about 0.5 wt. % to about 2 wt. %.

Similarly, the protein enriched hummus composition can comprise processing aids to facilitate the processing of the hummus composition during the combining, shearing/mixing, and/or sterilization steps, or any other step of the process. In certain embodiments, processing aids can comprise phosphate salts such as sodium hexametaphosphate and/or disodium potassium phosphate. The acidifying agents listed above also can function as a processing aid, in certain embodiments. The amount of the processing aid is not limited to a particular range, and in some embodiments can be less than 1 wt. %, less than 0.5 wt. %, less than 0.2 wt. %, less than 0.1 wt. %, or less than 0.05 wt. %.

Protein enriched hummus compositions disclosed herein can comprise thickeners, such as tamarind gum, in any amount that improves the consistency or processibility of the compositions. For instance, hummus compositions of the present invention can comprise tamarind gum in an amount less than about 1 wt. %, less than about 0.5 wt. %, less than about 0.3 wt. %, or less than about 0.2 wt. %. In certain embodiments, the amount of thickener can be in a range from about 0.1 wt. % to about 0.3 wt. %, or from about 0.15 wt. % to about 0.2 wt. %.

The protein enriched hummus compositions disclosed herein can comprise additional additives and preservatives, as noted hereinabove. In contrast, certain embodiments of the protein enriched hummus compositions disclosed herein can contain no artificial preservatives. Regardless, although the refrigerated shelf life (at 34° F.) of the hummus compositions disclosed herein is not limited to any particular range, in certain embodiments, the refrigerated shelf life can be at least 7 days, at least 14 days, at least 30 days, at least 60 days, at least 90 days, or at least 120 days.

In certain embodiments, the taste of the protein enriched hummus compositions disclosed herein can be improved relative to an otherwise identical hummus composition without non-leguminous protein. For example, certain embodiments of the protein enriched hummus compositions disclosed herein can have an average taste score in a blinded taste test in a range from about 4 to about 10, where the taste test has a scale of 1 to 10 (or its weighted equivalent), 10 being the best taste. Moreover, certain embodiments can have a higher average taste score in a blinded taste test than that of an otherwise identical hummus composition without non-leguminous protein. For instance, the average taste score of the protein enriched hummus compositions disclosed herein can be 1, 2, 3, 4, 5, 6, 7, 8, or 9 higher than that of an otherwise identical hummus composition without non-leguminous protein, on a scale from 1 to 10 (or its weighted equivalent). Moreover, the protein enriched hummus compositions also may have the same scores and/or ranges of scores for other specific characteristics related to taste, e.g., freshness, flavor, aroma, etc.

In certain embodiments, the texture (e.g., smoothness, creaminess, etc.) of the protein enriched hummus compositions disclosed herein can be improved relative to an otherwise identical hummus composition without non-leguminous protein. For example, certain embodiments of the protein enriched hummus compositions disclosed herein can have an average smoothness score in a blinded taste test in a range from about 4 to about 10, where the taste test has a scale of 1 to 10 (or its weighted equivalent), 10 being the smoothest. Moreover, certain embodiments can have a higher average smoothness score in a blinded taste test than that of an otherwise identical hummus composition without non-leguminous protein. For instance, the average smoothness score of the protein enriched hummus compositions disclosed herein can be 1, 2, 3, 4, 5, 6, 7, 8, or 9 higher than that of an otherwise identical hummus composition without non-leguminous protein, on a scale from 1 to 10 (or its weighted equivalent).

Similarly, certain embodiments of the protein enriched hummus compositions disclosed herein can have an average creaminess score in a blinded taste in a range from about 4 to about 10, where the test taste has a scale of 1 to 10 (or its weighted equivalent), 10 being the creamiest. Moreover, certain embodiments can have a higher average creaminess score in a blinded taste test than that of an otherwise identical hummus composition without non-leguminous protein. For instance, the average creaminess score of the protein enriched hummus compositions disclosed herein can be 1, 2, 3, 4, 5, 6, 7, 8, or 9 higher than that of an otherwise identical hummus composition without non-leguminous protein, on a scale from 1 to 10 (or its weighted equivalent).

In certain embodiments, the viscosity of the protein enriched hummus composition is not limited to any particular range; however, the viscosity generally can be in any range suitable to afford favorable characteristics (e.g., spreadability, dip-ability, etc.) to the protein enriched hummus composition. For example, in certain embodiments, the viscosity (at about 20° C. to about 25° C.) of the protein enriched hummus composition can be in a range from about 1,000 cP to about 150,000 cP, from about 3,000 cP to about 120,000 cP, from about 5,000 cP to about 100,000 cP, from about 10,000 cP to about 70,000 cP, from about 30,000 cP to about 50,000 cP, from about 50,000 cP to about 100,000, cP or from about 70,000 cP to about 150,000 cP.

As noted above, the viscosity of protein enriched hummus compositions may improve the spreadability and/or dip-ability relative to that of an otherwise identical hummus composition without non-leguminous protein. As such, certain embodiments of the protein enriched hummus compositions disclosed herein can have an average spreadability score and/or dip-ability score in a blinded test in a range from about 4 to about 10, where the test has a scale of 1 to 10 (or its weighted equivalent), 10 being the most spreadable or most dip-able. Moreover, certain embodiments can have a higher average spreadability score and/or dip-ability score in a blinded test than that of an otherwise identical hummus composition without non-leguminous protein. For instance, the average spreadability score and/or dip-ability score of the protein enriched hummus compositions disclosed herein can be 1, 2, 3, 4, 5, 6, 7, 8, or 9 higher than that of an otherwise identical hummus composition without non-leguminous protein, on a scale from 1 to 10 (or its weighted equivalent). Moreover, the unrefrigerated serving life of the protein enriched hummus compositions disclosed herein can be prolonged relative to an otherwise identical hummus composition without non-leguminous protein, by delaying the formation of a hardened film atop the hummus through increased viscosity.

Processes to Produce Protein enriched Hummus Products

Processes to produce protein enriched hummus mixtures and methods for improving the consistency of protein enriched hummus mixtures are disclosed and described herein. These processes and methods can provide a hummus product with improved nutritional value and a creamier, more desirable consistency. Processes to prepare protein enriched hummus products including packaging and/or sterilizing protein enriched hummus mixtures also are disclosed herein. In certain embodiments, processes to prepare protein enriched hummus products do not significantly alter the composition and/or physical characteristics of the protein enriched hummus mixtures. Therefore, the characteristics of the protein enriched hummus compositions of this invention, disclosed hereinabove, can be identical to those of any protein enriched hummus mixtures and protein enriched hummus products disclosed herein. Moreover, the processes disclosed herein can be employed to produce the protein enriched hummus compositions having any of the ingredients and characteristics described hereinabove, and in any combination.

In certain embodiments, for example, a process to produce a hummus product and/or a method to improve the consistency of a hummus product can comprise combining a cooked chickpea component with a non-leguminous protein to form a protein enriched hummus mixture. Often, the consistency of protein enriched hummus mixtures prepared by processes disclosed herein can be better than or equal to that of an otherwise identical hummus mixture without the non-leguminous protein, under the same process conditions and formulation. In certain embodiments, the weight ratio of the cooked chickpea component to the non-leguminous protein can be at least about 1:1, at least about 3:1, at least about 5:1, at least about 10:1, or at least about 15:1. Illustrative and non-limiting embodiments can comprise the cooked chickpea component and the non-leguminous protein in a weight ratio in a range from about 1:1 to about 25:1, from about 3:1 to about 15:1, from about 5:1 to about 15:1, or from about 3:1 to about 10:1.

The preparation of the cooked chickpea component is not limited to any particular method. For instance, in certain embodiments, the cooked chickpea component can be steamed, either at atmospheric pressure or in a pressurized vessel. In other embodiments, the cooked chickpea component can be prepared by (a) soaking chickpeas in water or brine (as described herein) to form soaked chickpeas, (b) boiling the soaked chickpeas in water or brine, either the same or different than that used in step (a), and (c) removing at least a portion of the liquid from the prepared chickpea mixture.

The duration of steps (a)-(c) is not limited to any particular period of time. In certain embodiments, for example, the duration of the soaking step can be in a range from about 5 min to about 48 hr, from about 10 min to about 24 hr, from about 30 min to about 24 hr, from about 30 min to about 12 hr, from about 10 min to about 3 hr, from about 5 hr to about 25 hr, from about 10 hr to about 18 hr, or from about 12 hr to about 14 hr. Similarly, the duration of the boiling step can be in a range from about 5 min to about 6 hr, from about 10 min to about 3 hr, from about 10 min to about 1 hr, or from about 5 min to about 30 min.

Generally, the combining step is not limited by the order, or number of additions. In certain embodiments, for example, the non-leguminous protein can be combined with the cooked chickpea component in a mixing vessel to form a protein enriched hummus mixture. In other embodiments, the process can further comprise combining additional ingredients as described above (e.g., olive oil, lemon juice, salt, garlic, brine, tahini, sesame seeds, avocado, olives, peppers, an additional leguminous protein, etc.). In processes comprising combining brine to form a protein enriched hummus mixture, the brine can be a portion of the liquid removed from the prepared chickpea mixture in step (c), in order to preserve the nutritional value present in the liquid that would otherwise be discarded.

In certain embodiments, the combining step(s) can be performed in a vessel with a mixing device. The mixing device is not limited to any specific design or functionality, and can comprise rotating blades, arms, bars, beaters, etc., configured to combine or mix the ingredients (e.g., cooked chickpea component, non-leguminous protein, etc.) to form the protein enriched hummus mixture. Commonly, ingredients of the protein enriched hummus mixture can be added to the vessel prior to conducting the combining step, such as prior to activating the mixing device. In alternate embodiments, ingredients of the protein enriched hummus mixture can be added to the vessel during the combining step (e.g., while the mixing device is operating). For example, in certain embodiments, an acidifying agent (e.g., glucono delta-lactone) can be added during the combining step to gradually lower the pH of the protein enriched hummus mixture, and ensure that the pH does not vary significantly from one portion of the mixture to another.

As for the preparation of the protein enriched hummus mixture, the duration of the combining step(s) is not limited to any particular period of time. In certain embodiments, for example, the combining step(s) can be conducted for at least 3 sec, at least 5 sec, at least 10 sec, at least 30 sec, at least 1 min, or at least 5 min. Typical ranges for the combining step can include, but are not limited to, from about 5 sec to about 10 min, from about 30 sec to about 5 min, or from about 2 min to about 4 min.

In another embodiment, the combining step—combining the cooked chickpea component with the non-leguminous protein to form the protein enriched hummus mixture—can be preceded by a step of shearing or mixing the non-leguminous protein with brine (e.g., chickpea brine) [what is the typical composition of the brine???] to form a sheared mixture. While not wishing to be bound by theory, it is believed that the treatment of the non-leguminous protein (such as whey protein) in this manner can reduce or prevent binding, gelation, and/or coagulation that may occur, and result in a hummus product with a smoother and creamier texture. In certain embodiments, an antifoaming agent or emulsifier can be added during the shearing or mixing step. Following the shearing or mixing step, the sheared mixture can be left to hydrate, typically without agitation, for a suitable period of time. Once the shearing or mixing step and hydration are complete, the sheared mixture (non-leguminous protein and brine component) can be combined with other ingredients, such as the cooked chickpea component and other additives, as described herein, to form the protein enriched hummus mixture.

Generally, the ratio of brine to the non-leguminous protein can be any amount amenable to the shearing or mixing process, for example, any ratio that results in a desirable consistency of the hummus product and can be adequately mixed. However, excess brine in the mixture may reduce the effectiveness of the shearing or mixing, while too little brine may make the non-leguminous protein too difficult to manipulate during the shearing step. Accordingly, in some embodiments, the weight ratio of brine:protein can be at least 1:1, at least 2:1, at least 3:1, at least 5:1, or at least 10:1. In other embodiments, the weight ratio of brine:protein in the shearing or mixing step, and present in the sheared mixture, can be in a range from about 1:1 to about 8:1, from about 1.5:1 to about 5:1, or from about 2:1 to about 4:1. Also, as above, the duration of the shearing and hydration steps is not limited to any particular period of time. For instance the duration of the shearing or mixing step can be in a range from about 30 sec to about 1 hr, from about 1 min to about 30 min, from about 3 min to about 15 min, or from about 1 min to about 10 min. Similarly, the duration of the hydration step can be in a range from about 5 min to about 4 hr, from about 15 min to about 2 hr, or from about 30 min to about 1 hr.

Processes and methods of the invention disclosed herein can further comprise sterilizing the protein enriched hummus mixture to form a protein enriched hummus product. The sterilization of the protein enriched hummus mixture is not limited to any particular method. In certain illustrative and non-limiting examples, the protein enriched hummus mixture can be sterilized by a cold pasteurization technique, such as high pressure processing. Such processes can provide an advantage to the protein enriched hummus product by eliminating the need for artificial preservatives and extending its shelf-life. Moreover, high-pressure processing sterilization does not alter the composition or significantly alter the physical characteristics of the protein enriched hummus mixture. Therefore, embodiments where the sterilization step comprises high pressure processing often produce a protein enriched hummus product with characteristics essentially identical to the protein enriched hummus mixture.

As would be understood by a person of skill in the art, high pressure processing can comprise introducing a sealed product in a container, such as the protein enriched hummus mixture, and subjecting the sealed product to pressures typically in a range of 300-600 MPa. The pressures can be achieved by loading a pressurization chamber with water, pressurizing the chamber until the sealed product has been sufficiently sterilized, and then releasing the pressure, water, and sealed product in succession.

As the ‘cold pasteurization’ moniker implies, the sterilization step can be conducted without the use of extreme temperatures that can compromise the quality of the protein enriched hummus product. In certain embodiments, the sterilization step can be conducted at room temperature, or without any external heating or cooling. In certain embodiments, the temperature of the product during the sterilization step can be from about 0° C. to about 70° C., from about 0° C. to about 50° C., or from about 10° C. to about 30° C.

An illustrative and non-limiting example of the processes to produce a hummus product, and the methods to improve the consistency (or texture, or creaminess) of the hummus product, can begin by soaking chickpeas in water for 10-18 hr (or from 12-14 hr), followed by draining the liquid from the soaked chickpeas and rinsing. Then, water is added to the soaked chickpeas with salt (10-50 grams per kg of chickpeas), and the resulting mixture can be boiled for 30-90 min (or for about 1 hr) at a temperature in the 100-125° C. range (or in the 100-112° C. range) to form a prepared chickpea mixture. The prepared chickpea mixture then can cool and settle, typically for about 1 hr, although not limited thereto. The prepared chickpea mixture is separated into a liquid component (chickpea brine) and a cooked chickpea component. At least a portion of the chickpea brine can be added to whey protein (or other non-leguminous protein source) and mixed or sheared, adding an antifoaming agent as necessary, for several minutes. The resulting sheared mixture can be allowed to settle and hydrate for 15-90 min (or from 30-45 min) before combining with the cooked chickpea component and other additives or ingredients, as described herein. Once all ingredients have been combined to form the protein enriched hummus mixture, the mixture can be filled into suitable containers in preparation for high pressure processing (or other sterilization technique). The protein enriched hummus products prepared by these processes have a surprising combination of excellent taste and high protein content, as well as improved consistency, texture, and creaminess.

While not wishing to be bound by theory, it is believed that for whey protein, it can be advantageous for the source of the whey protein (e.g., whey protein isolate, whey protein concentrate, etc.) to have a high whey protein content, such as greater than about 85 wt. %, greater than about 90 wt. %, greater than about 95 wt. %, greater than about 98 wt. %, or greater than about 99 wt. %, of whey protein. Generally, such high-purity whey protein sources often have less than about 5 wt. %, less than about 2.5 wt. %, less than about 1 wt. %, less than about 0.5 wt. %, or effectively no measurable amount, of glycomacropeptide (a casein protein fragment). The use of high-purity whey protein sources to produce the protein enriched hummus mixture, after high pressure treatment, resulted in a creamy hummus product with an excellent taste and flavor profile. In contrast, whey protein sources of lower purity, such as containing 15-30 wt. % of glycomacropeptide, after high pressure treatment, often resulted in gelled/clumpy hummus products with significant off-taste (cheesy).

### EXAMPLES

The invention is further illustrated by the following examples, which are not to be construed in any way as imposing limitations to the scope of this invention. Various other embodiments, modifications, and equivalents thereof which, after reading the description herein, may suggest themselves to one of ordinary skill in the art without departing from the spirit of the present invention or the scope of the appended claims.

Table I summarizes certain predicted characteristics of Comparative Example 1 and Inventive Examples 2-3. Generally, Examples 1-3 comprise chickpeas, tahini, lemon juice, aquafaba, olive oil, salt, garlic, and glucono delta-lactone, differing only in the amount of non-leguminous protein present in the hummus product. Comparative Example 1 contained no non-leguminous protein, whereas Inventive Examples 2-3 comprised 5 wt. % whey protein isolate and 10 wt. % whey protein isolate, respectively.

Examples 1-3 were prepared by first soaking chickpeas in water for about 10 hr to about 14 hr, then boiling the soaked chickpeas for about 45 min to about 90 min. The liquid used in the boiling step (i.e., aquafaba) was separated and set aside, and between 110 g and 120 g of the cooked chickpeas were added to the basin of a STEPHAN mixer. In Examples 2-3, whey protein isolate (from about 10 g to about 25 g; Glanbia Nutritionals or Agropur) was also added to the basin of the mixer. Additional ingredients were added to the basin of the mixer, including from about 25 g to about 50 g of tahini, from about 10 g to about 20 g of lemon juice, from about 2 g to about 4 g extra virgin olive oil, from about 1 g to 2 g salt, from about 0.5 g to about 1 g of garlic clove, and from about 5 g to about 40 g of the aquafaba removed from the cooked chickpea component. In other examples (not in Table I), red peppers or avocados were added in an amount from about 20 g to about 40 g. In an additional example (not in Table I), extra virgin olive oil and salt were substituted by about 20 g to about 40 g of Kalamata olives. The ingredients were mixed together by serrated blades of the mixer for about 60 sec to about 90 sec. Glucono delta-lactone was added during the mixing step until the pH of the hummus mixture was in a range from about 4.2 to about 4.6 (typically from about 3 g to about 4 g). The hummus mixture was removed from the mixer and packaged in a container. The container was then subjected to high pressure processing to give the sterilized hummus products, as disclosed hereinabove.

The hummus products of Examples 1-3 can be evaluated for certain desirable characteristics regarding the texture, consistency, and taste of the hummus products. Viscosity can be measured according to standard techniques and a common model rheometer. As discussed above, creaminess, spreadability, and taste can be assessed through blinded tests, where a large number of hummus consumers individually assign scores to the products of Examples 1-3 based on a scale from 1 to 10, 10 being the highest (i.e., creamiest, most spreadable, best taste, etc.). The scores given to the hummus products can be averaged predicted values shown below in Table I.

TABLE I
Added protein content and predicted characteristics of Examples 1-3.

| | | | Predicted | Predicted | Predicted |
|---|---|---|---|---|---|
| | | | Average | Average | Average |
| | Whey Protein | Predicted | Creaminess | Spreadability | Taste |
| Example | Isolate (wt. %) | Viscosity | Score | Score | Score |
| Comparative Example 1 | 0 | 500 cP | 2 | 2 | 3 |
| Inventive Example 2 | 5 | 5,000 cP | 5 | 5 | 5 |
| Inventive Example 3 | 10 | 50,000 cP | 10 | 10 | 10 |

We claim:

1. A process to produce a hummus product, the process comprising:
combining a cooked chickpea component with a non-leguminous protein to form a protein enriched hummus mixture; wherein:
an amount of the non-leguminous protein in the hummus product is in a range from about 2 wt. % to about 30 wt. %; and
a weight ratio of non-leguminous:leguminous protein in the hummus product is in a range from about 2:1 to about 10:1.

2. The process of claim 1, wherein a weight ratio of the cooked chickpea component to the non-leguminous protein is in a range from about 3:1 to about 15:1.

3. The process of claim 1, wherein the non-leguminous protein comprises whey protein isolate, whey protein concentrate, casein, or a combination thereof

4. The process of claim 1, wherein the process comprises:
(i) mixing the non-leguminous protein with brine to form a sheared mixture; and
(ii) combining the sheared mixture with the cooked chickpea component to form the protein enriched hummus mixture.

5. The process of claim 4, wherein:
the brine comprises aquafaba; and
the process further comprises a step of hydrating the sheared mixture prior to step (ii).

6. The process of claim 1, wherein the combining step further comprises adding olive oil, lemon juice, salt, garlic, brine, tahini, sesame seeds, or any combination thereof, to form the protein enriched hummus mixture.

7. The process of claim 1, wherein the combining step further comprises adding avocado, olives, peppers, or any combination thereof, to form the protein enriched hummus mixture.

8. The process of claim 1, wherein:
the combining step further comprises adding an acidifying agent to form the protein enriched hummus mixture; and
the acidifying agent comprises glucono delta-lactone, citric acid, tartaric acid, ascorbic acid, fumaric acid, lactic acid, vinegar, or any combination thereof.

9. The process of claim 1, further comprising sterilizing the protein enriched hummus mixture to form the hummus product.

10. The process of claim 1, wherein the hummus product comprises from about 8 wt. % to about 40 wt. % protein.

11. The process of claim 10, wherein:
the non-leguminous protein comprises whey protein; and
the hummus product comprises from about 12 wt. % to about 20 wt. % protein.

12. The process of claim 1, wherein the pH of the hummus product is in a range from about 4.2 to about 4.6.

13. The process of claim 1, wherein the hummus product has a refrigerated shelf life at 34° F. of at least about 60 days.

14. A method for improving the consistency of a hummus product, the method comprising:
combining a cooked chickpea component with a non-leguminous protein to form a protein enriched hummus mixture, wherein the weight ratio of the cooked chickpea component to the non-leguminous protein is in a range from about 3:1 to about 15:1.

15. The method of claim 14, wherein the cooked chickpea component is prepared by a process comprising:
(a) soaking chickpeas in water to form soaked chickpeas;
(b) boiling the soaked chickpeas in water to form a prepared chickpea mixture; and
(c) removing at least a portion of a liquid from the prepared chickpea mixture to form the cooked chickpea component.

16. The method of claim 15, wherein combining the cooked chickpea component with the non-leguminous protein to form the protein enriched hummus mixture comprises the steps of:
(i) mixing the non-leguminous protein with at least a portion of the liquid removed from the prepared chickpea mixture to form a sheared mixture; and
(ii) combining the sheared mixture with the cooked chickpea component to form the protein enriched hummus mixture.

17. The method of claim 14, wherein:
the method further comprises a step of sterilizing the protein enriched hummus mixture using high pressure processing to form the hummus product;
the pH of the hummus product is in a range from about 4.2 to about 4.6; and
the hummus product has a refrigerated shelf life at 34° F. of at least about 60 days.

18. A hummus product comprising:
(i) chickpeas; and
(ii) from about 2 wt. % to about 30 wt. % of a non-leguminous protein, based on the weight of the hummus product.

19. The hummus product of claim 18, wherein the hummus product comprises:
from about 6 wt. % to about 20 wt. % of the non-leguminous protein; and
from about 10 wt. % protein to about 25 wt. % protein.

20. The hummus product of claim 18, wherein:
the pH of the hummus product is in a range from about 4.2 to about 4.6;
the hummus product has a refrigerated shelf life at 34° F. of at least about 60 days;
a weight ratio of non-leguminous:leguminous protein in the hummus product is in a range from about 2:1 to about 6:1; and
the hummus product comprises from about 6 wt. % to about 20 wt. % of the non-leguminous protein, and the non-leguminous protein comprises whey protein.
